(19) United States
(12) Patent Application Publication
(10) Pub. No.: US 2023/0383803 A1
(43) Pub. Date: Nov. 30, 2023

(54) Brake assembly and method for operating a brake assembly for a vehicle wheel

(71) Applicant: HL MANDO CORPORATION, Pyeongtaek (KR)

(72) Inventor: Hatem SHAHIN, Pfaffenhofen (DE)

(21) Appl. No.: 18/325,088

(22) Filed: May 29, 2023

(30) Foreign Application Priority Data
May 30, 2022 (DE) 102022205364.8

(51) Int. Cl. F16D 65/22; F16D 55/04

(52) U.S. Cl. CPC F16D 65/22; F16D 55/04; F16D 2121/24

(57) ABSTRACT

The invention concerns a brake assembly for a vehicle wheel,
the brake assembly comprising:
   a braked member that is coupable or coupled to the vehicle wheel for a joint rotation therewith about a rotational axis, the braked member having friction linings that are arranged at an axial distance from one another; and
   a braking unit that comprises an actuator and at least two displaceable members, the displaceable members being positioned in between the friction linings,
wherein the actuator is configured move the displaceable members axially apart from one another, thereby bringing each displaceable member into contact with one of the friction linings of the braked member.

### CROSS-REFERENCE TO RELATED APPLICATION

This application is based on and claims priority under 35 U.S.C. § 119 to German Patent Application No. 102022205364.8, filed on May 30, 2022 in the German Patent and Trade Mark Office, the disclosures of which are incorporated herein by reference.

### TECHNICAL FIELD

The invention relates to a brake assembly and to a method for operating a brake assembly. The brake assembly acts on a vehicle wheel, e.g. of a road vehicle, such as a car or a truck.

### BACKGROUND

It is known to provide brakes for vehicle wheels and in particular for individually braking a vehicle wheel. Typically, disc brakes or drum brakes are used. In case of disc brakes, brake pads are arranged at different sides of a brake disc and are axially moved towards one another to clamp the brake disc in between them. In case of drum brakes, brake pads are radially moved to contact a rotating brake drum.

While both of these established designs have distinct advantages, there still remains room for improvement. For example, the generation of brake noises and the emission of brake dust remains an issue.

### SUMMARY

Therefore, it is an object of this invention to provide a brake assembly that limits at least some of the disadvantages of existing brake assemblies.

This object is solved by the subject matter of the attached independent claims. Advantageous embodiments are defined in the dependent claims and in this description.

Accordingly, a brake assembly for a vehicle wheel is disclosed,

the brake assembly comprising:
a braked member that is coupable or coupled to the vehicle wheel for a joint rotation therewith about a rotational axis, the braked member having friction linings that are arranged at an axial distance from one another; and
a braking unit that comprises an actuator and at least two displaceable members, the displaceable members being positioned (e.g. axially) in between the friction linings,
   wherein the actuator is configured move the displaceable members axially apart from one another, thereby bringing each displaceable member into contact with one of the friction linings of the braked member. This way, a braking effect is achieved.

Terms such as axial, radial and circumferential may generally refer to the rotational axis. A radial direction may extend at an angle and in particular orthogonally to the rotational axis, whereas a circumferential direction may extend about or around the rotational axis.

With the above configuration, an arrangement of the braked member similar to existing disc brake designs may be provided. That is, the braked member may extend at an angle and in particular orthogonally to the rotational axis and the brake pads are preferably axially displaceable as well. This is different from typical drum brake designs in which the brake pads are moved radially.

Yet, in the present case the displaceable members are preferably axially positioned in between contact surfaces of the braked member, said contact surfaces being formed by the friction linings. This is different from said contact surfaces (such as in existing disc brakes) being positioned in between the displaceable members. Further, during braking the displaceable members are axially moved apart from one another or, put differently, are axially spread. In consequence, they can be brought into contact with a respectively adjacent or opposite friction lining, thereby generating frictional forces providing a braking effect. This can also be referred to as the braking unit tightening or tensioning within the braked member by pushing its displaceable members outwards against the contact surfaces.

Another difference to existing brake designs is the positioning of the friction linings. Presently, these are arranged at the member that is to be braked and jointly rotates with a vehicle wheel. The displaceable members, which may also be referred to as brake pads (or, more precisely, may be referred as brake pads without a friction material), may be free of any friction lining. They may be one-piece or multi-piece members. Their axial thickness may be constant or variable.

The positioning of the friction lining at the braked member allows the friction lining to have an enlarged surface area, e.g. compared to arranging it at common brake pads. For example, the friction lining may extend along a circumferential length that exceeds a comparable dimension of existing brake pads or brake shoes of brake assemblies with similar brake performances. This increased surface area may improve heat dissipation, thus e.g. limiting thermal deformation of members of the brake assembly which could otherwise contribute to noise generation.

Also, the increased surface area may limit local wear, thus increasing lifetime of the friction lining. Compared to existing brake pads or brake shoes of brake assemblies with similar brake performances, the friction linings and thus the braked member may thus have to be less frequently replaced. Moreover, compared to common friction linings at displaceable brake pads, the present friction linings may have a reduced thickness, e.g. of less than 5 mm or less than 2.5 mm (e.g. between and including 1.5 mm and up to 2 mm) The suggested brake assembly is also advantageous in that new design parameters are available that can be optimised for avoiding existing disadvantages. For example, the braked member may be dimensioned differently from existing single brake discs and may in particular be at least somewhat axially wider and/or more rigid. This may be advantageous in terms of reducing vibrations and/or noises during braking. Also, this helps to avoid Eigenfrequencies in frequency ranges that have been found to be critical for brake noise generation, such as a frequency range from 1000 Hz to 6000 Hz.

Further, with the suggested design, components of the brake assembly, such as the actuator and the displaceable members, can be at least partially shielded from the environment due to being accommodated within the braked member (e.g. within a ring-shaped recess comprised by the braked member). This provides protection, e.g. from humidity, dirt or weather conditions, and can thus help to improve longevity of the brake assembly.

Further, it can help to reduce emissions of brake dust into the environment and/or may provide a noise shielding effect.

The braked member may have brake disc portions discussed in further detail below. These may be lighter compared to existing brake discs, e.g. due to the braked member comprising a stiffening connecting portion and/or the displaceable members taking on a larger share of an overall thermal mass.

Due to its reduced weight and/or generally a lower heat dissipation (e.g. due to the at least somewhat heat-insulating friction layer), the brake disc portions (or the braked member in general may) have a reduced axial thermal expansion. This reduces a risk of undesired drag torque when the brake is inactive.

The fractioning linings may comprise (e.g. planar and/or smooth and/or slotted) contact surfaces facing a respectively adjacent displaceable member.

They may comprise or be made from a friction material. The friction material may comprise, for example, friction fibers or friction particles (e.g. metallic particles) and a binder. Accordingly, the friction material may be or comprise a material composition with particles and/or fibers distributed in a (rigid) binder material. The friction linings may experience wear and in particular stronger wear than the displaceable members.

According to a further embodiment, the displaceable members (e.g. at least their contact surfaces) comprise a material that is different from a material comprised by the friction lining. In particular, said material may not be a friction material. In one example, said material comprised by the displaceable members is harder and/or more wear resistant than a material comprised by the friction linings. For example, the displaceable members may comprise a metallic material, such as cast iron, to promote heat dissipation.

In one example, the friction linings are arranged at brake disc portions and/or disc-like members comprised by the braked member. For example, each brake disc portion may support (or, in other words, carry) one of the friction linings. Accordingly, the braked member may comprise two brake disc portions that are axially spaced apart from one another. In the (axial) space between said brake disc portions, the displaceable members may be received. In this case, the friction linings may be arranged at the faces of the brake disc portions that face one another. The braked member may comprise a connecting portion connecting the brake disc portions, such as an axially extending hub portion.

The brake disc portions may comprise recesses, e.g. extending from an axially outer face axially inward.

The braked member can, additionally or alternatively, be considered to represent a disc member or a cylindric member, said member e.g. having a circumferential and/or or ring-shaped circumferential recess or slot in which the displaceable members are positioned. In this case, the friction linings may be arranged at inner or internal surfaces of said slotted disc or cylindric member.

The actuator may operate e.g. hydraulically or electrically. The actuator may be configured to simultaneously displace the brake pads towards a respectively opposite friction lining. In one example, the actuator comprises a hydraulic chamber and both the displaceable members are displaceable when generating pressure in said hydraulic chamber. For example, each displaceable member can be coupled to a respectively associated piston, said piston being hydraulically coupled to and/or received in the hydraulic chamber. For example, the pistons may be arranged at and/or coupled to opposite sides of the hydraulic chamber. They may axially be pushed out of and/or away from a center of the hydraulic chamber when a brake pressure is built up therein.

The actuator may be, may represent or may comprise a brake caliper. In particular, the brake caliper may be a fixed caliper with e.g. only the pistons attached to each displaceable member moving relative to a caliper housing.

Contrary to existing disc brake caliper designs, in the present case the brake caliper may move the displaceable members axially apart from one another, e.g. due to being positioned axially in between them and pushing its pistons axially outward during a brake activation. When configured as an electric actuator, the actuator may comprise a spindle mechanism. Again, the electric actuator may be configured to simultaneously displace the displaceable member to generate brake forces and/or may be axially positioned in between them.

Each displaceable member may face a respectively adjacent or opposite friction lining, in particular when viewed along the rotational axis. On the other hand, the displaceable members (in particular their contact surfaces for contacting one of the friction linings) may face away from one another. The displaceable members are preferably arranged on opposite sides of the actuator and/or caliper and/or housing. When being moved apart from one another, an axial distance between the displaceable members may increase.

An axial distance between each displaceable member and a respectively opposite friction lining may be reduced to zero, so that a contact is established.

When viewed in an axial direction, the displaceable members can be accommodated within a space (e.g. formed by the circumferential slot or recess discussed above), the space being (axially) confined by the friction linings. Put differently, at least part of the displaceable members can be arranged or be received inside the braked member.

The brake assembly preferably forms part of a vehicle wheel brake for braking an individual wheel of the vehicle. Accordingly, the braked member may be connected to a wheel hub or axle component that is connected to said specific wheel. In one aspect, the brake assembly is not part of a vehicle axle brake and/or does not act on a vehicle axle to which a plurality of wheels is connected, e.g. a left and a right wheel. Generally, the brake assembly is optionally arranged at and/or adjacent to the wheel that it is supposed to brake.

Additionally or alternatively, the brake assembly may be arranged within a rim of the wheel to be braked. For example, its radial dimension may be smaller than the (in particular inner) radial dimension of the tire-carrying portion of the rim. Also, the brake assembly may at least partially axially overlap with the rim. Generally, the brake assembly may at least partially be received in the rim. This increases compactness and reduces the space requirements (put differently, packaging requirements or installation space requirements) of the brake assembly within the vehicle.

According to a preferred embodiment, the friction linings face each other. In other words, they may be positioned axially opposite to one another.

For example, the friction linings may form at least part of opposite side faces, the side faces belonging to and/or confining a space (or recess or slot) in which the displaceable members are at least partially received.

Accordingly, the braked member may generally provide a space for receiving the displaceable members. This space may e.g. be a ring-shaped recess or a circumferential slot as noted above.

The space may be opened at an radially outer or upper side. In the axial direction, it may be confined by the friction linings. In the circumferential direction, it may be continuous and/or non-obstructed (i.e. ring shaped). A radially inner or lower side (or bottom face) may be confined by a connection portion of the braked member e.g. connecting faces at which the friction linings are arranged.

The space may have a radial depth or a radial extension that is larger than a radial extension of the displaceable members. This way, the displaceable members can be fully arranged within and/or may be sunken into this space.

Similarly, at least part of the actuator (in particular a possible brake caliper thereof) may be received within the space.

An axial width of the space may be dimensioned so that a gap can be provided between each displaceable member and a respectively opposite friction lining when the brake is inactive. This helps to reduce drag torque that could otherwise be caused by a maintained contact between the displaceable members and contact surfaces even though the brake is not activated.

According to a preferred embodiment, a brake dust collector is arranged within the space, in particular at a bottom face that extends in between the friction linings. The brake dust collector may e.g. be formed as a ring-shaped lining or ring-shaped member. It may comprise an adhesive, so that the brake dust may adhere thereto. The brake dust collector may be exchanged during maintenance, once it has collected a large amount of brake dust. This way, it can be disposed of appropriately without the brake dust being randomly and continuously emitted into the environment when operating the vehicle.

In one aspect, the displaceable members are axially movable apart from one another. This may include the displaceable members being movable along an axis that extends in parallel to the rotational axis. Generally, the movement of the displaceable members may be linear, e.g. by being pushed towards the friction linings in a straight movement.

Yet, axially moving the displaceable members apart is not to be understood limiting with respect to the type of movement. For example, a rotational or tilted movement or each displaceable member moving along an individual movement axis may be implemented. This may equally result in an axial distance between the displaceable members increasing when braking.

In one example, the displaceable members are tilted with respect to one another and/or are each movable along a movement axis, the movement axes of the displaceable members being tilted relative to one another. For example, the movement axes may together define a V-shape. Accordingly, the displaceable members may be moved axially apart from one another while altering a distance to the rotational axis. For example, said distance may be lowered or increased. The displaceable members may thus be axially pushed apart while being radially lowered or raised accordingly. The contact surfaces may be oriented and in particular tilted similarly, e.g. so as to extend in parallel to contact surfaces of the displaceable members. For example, the contact surfaces may be tilted inwardly and/or towards their respective opposite friction surface, which may limit bending.

This way, contact forces may be exerted by the displaceable members not only in an axial direction, but at least partially also at an angle to the rotational axis. This may be beneficial form a constructional point of view, e.g. in terms of stress distribution.

According to a preferred embodiment, the friction linings are each comprised by brake disc portions (e.g. provided in form of distinct brake discs) of the braked member. For example, a first brake disc portion may comprise a first friction lining and a second brake disc portion may comprise a second friction lining. The first and second friction lining may face one another.

At the respective other surface of each brake disc portion that faces axially outward, no brake forces may be generated. That is, the internally arranged displaceable members may be the only displaceable members acting on a respective friction lining. Yet, according to other embodiments, additional displaceable members may be provided which act on said axially outward facing surface of at least one of the brake disc portions as well.

The brake disc portions may be configured according to known examples. Yet, they may deviate from existing designs with respect to their fixation within brake assembly and e.g. to a connection portion of the braked member that axially extends in between the brake disc portions. For example, the connection portion carries the brake disc portions and/or connects them to one another.

Generally, the braked member may be a multi-part member but can also be a one-piece member. The braked member (or at least its brake disc portions and/or connecting portion) can be rotation symmetric with respect to the rotational axis.

It may generally be provided that the brake disc portions extend in parallel to one another. In particular, the brake disc portions may each extend orthogonally to the rotational axis of the braked member.

In one example, at least one of the brake disc portions comprises a stiffening structure. The stiffening structure, which may e.g. be a preferably massive section of material, may be positioned on a side of the brake disc portion that is opposite to the side comprising the contact surface. This side may face away from the displaceable members. It may be an axially outer side. The stiffening structure may e.g. be a rib, a pillar or a web. It may connect the brake disc portions to another section of the braked member, e.g. to the connection portion. Generally, the stiffening structure may support the brake disc portions against extensive bending or defection during braking.

Additionally or alternatively, a radially inner base portion of each brake disc portion may be stiffer than its radially outer portion. This may help to compensate for increased bending stresses at said base. The increased stiffness may e.g. be achieved a stiffer material at said base, an increased material volume at said base and/or and increased axial width at said base. In one example, the axial width of each brake disc portion increases in a radial outward direction, e.g. stepwise or continuously.

The displaceable members can be movable relative to one another, preferably with both displaceable members being actively moved during braking.

According to one example, each of the displaceable members is displaceable relative to a housing of the braking unit. The housing of the braking unit may be a brake caliper or may be comprised by a brake caliper. It may contain a hydraulic chamber and/or an electric motor which are configured to generate forces for moving the displaceable members, i.e. which form or are comprised by the actuator of the braking unit. The braking unit housing may be received in the same space (e.g. the slot or recess) of the braked member as the displaceable members. The braking unit housing may be fixed in position, even during braking. Yet, especially when also comprising further displaceable members acting on axially outer contact surfaces as discussed below, the braking unit housing may comprise or be connected to other movable parts apart from the (inner) displaceable members, for example in order to provide a swimming saddle function.

Thus, according to a preferred example, the actuator comprises an electric motor or a hydraulic chamber. By means of each of the electric motor and hydraulic chamber, the force for moving both of the displaceable members can be generated. The electric motor or hydraulic chamber may be the single source for generating the respective force for moving both displaceable members or any displaceable members in case a respective larger number of displaceable members is provided.

The electric motor or hydraulic chamber may at least partially be arranged (axially) between the displaceable members and/or within the space of the braked member receiving the displaceable members. Accordingly, in a further embodiment at least part of the actuator or hydraulic chamber are received in said space.

According to a further embodiment, at least one further displaceable member is provided that can be brought into contact with a further (e.g. outer) contact surface facing away from at least one of the other (e.g. inner) contact surfaces. This further contact surface may be an axially outer surface of the braked member. It may not confine the space receiving the inner displaceable members that are moved apart. It may be provided on a rear side or outer side of a brake disc portion whose other face confines said inner space (and e.g. has a friction lining arranged thereat).

In one example, the braked member has two inner friction linings and two outer friction linings. The inner friction linings may be the friction linings discussed above that confine a space for receiving the displaceable members.

The outer friction linings may be configured similar to the further friction linings discussed above. They may face outwards. Displaceable members may be provided to contact each of the friction linings, so that there may be at least four displaceable members overall. The displaceable members contacting the outer friction linings may be axially movable and may in particular move axially inward. They may represent outer displaceable members whereas the displaceable members that are moved apart for contacting the inner friction linings may be referred to as inner displaceable members.

Preferably, each of the at least four displaceable members is movable by means of the same actuator. For example, they may each be connected to a common electric motor or a common hydraulic chamber. In one example, a caliper is provided comprising a hydraulic chamber that is coupled to pistons connected to each of the displaceable members. The caliper or a general housing of the braking unit may extend into the space receiving the inner displaceable members. It may also extend so as to have at least one portion opposite to and/or facing one of the outer friction linings. Preferably, there are two such portions overall facing both outer friction linings.

In any of the embodiments having four displaceable members, two pairs of displaceable members may be formed, each pair clamping one of the brake disc portions in between them. Still, however, this includes that the braking pads contacting the inner contact surfaces axially move apart from one another.

According to a further example, each of the displaceable members and the friction linings have a contact surface for contacting a respective other of the displaceable members and the friction linings, wherein at least one of the displaceable members and the friction linings has at least one recess in its contact surface. The recess may e.g. define a local dent, a notch or a slot. As discussed below, this may improve noise reduction.

In one embodiment, at least one of the displaceable members comprises at least one cavity and/or comprises at least one recess in a portion facing away from a respectively adjacent friction lining (e.g. at a rear side). This may lower the weight of the displaceable members and/or may increase a surface area of the displaceable members which promotes heat dissipation.

Optionally, the braked member comprises at least one underlayer at which one of the friction linings is arranged. The underlayer may comprise a material that is different from the material of any of the braked member and friction lining. The underlayer may generally be softer and/or less rigid and/or have a higher elastic deformability compared to any of the braked member and friction lining. It may have a thickness of less than 2 mm, e.g. between and including 0.3.mm and up to 1 mm. The underlayer may act as a vibration absorber, thereby helping to reduce the level of generated brake noises.

It may be provided that at least one of the friction linings has a (e.g. continuous or closed) ring shape or comprises a number of ring segments, e.g. placed at circumferential distances form one another. The ring or ring segments may extend about the rotational axis. The ring or ring segments may have flat faces formed by the friction lining and e.g. by a face thereof facing the respectively adjacent displaceable member. The ring shape or ring like arrangement of ring segments advantageously enlarges a contact surface of the friction lining.

In one embodiment, a contact between the friction lining and the displaceable members is formed (in particular only) in a radially outer portion of the braked member that is e.g. positioned at a radial distance to a hub portion of the braked member. For example, there may be at least one portion of the braked member and in particular of optional brake disc portions thereof that is radially inside of the radially outer portion and in which no respective contact is formed. The friction linings may be provided only in said radially outer portion. Generating braking forces at a respective radially increased distance to the rotation axis advantageously increases the so-called effective braking radius. Said effective braking radius acts as a lever arm, thus increasing the generated brake effect.

The invention also concerns a method of operating a brake assembly,

the brake assembly comprising:
a braked member that is coupable or coupled to a vehicle wheel for a joint rotation therewith about a rotational axis, the braked member having friction linings that are arranged at an axial distance from one another; and
a braking unit that comprises at least two displaceable members, the displaceable members being positioned in between the contact surfaces,
   wherein the method comprises: moving the displaceable members axially apart from one another, thereby bringing each displaceable member into contact with one of the friction linings of the braked member.

The method may comprise any further steps or measures to provide any operations and effects disclosed herein in connection with the brake assembly. Any disclosure in connection with the features of the brake assembly, such as possible variants thereof, equally applies to the similar features of the method.

### BRIEF DESCRIPTION OF DRAWINGS

Embodiments of the invention are described below with respect to the attached schematic figures. Similar features may be marked with same reference signs throughout the figures.

FIG. 1 is a cross-sectional view of a braked member of a brake disc assembly according to a first embodiment of the invention.

FIG. 2 is a cross-sectional view of a braked member of a brake disc assembly according to a second embodiment of the invention.

FIG. 3 is a cross-sectional view of part of a braked member of a brake disc assembly according to a third embodiment of the invention.

FIG. 4 is a cross-sectional view of part of a braked member of a brake disc assembly according to a fourth embodiment of the invention.

FIG. 5-6 are a cross-sectional views of a braked member of a brake disc assembly according to a fifth and sixth embodiment of the invention, the braked member having a dust collector.

FIG. 7 is a cross-sectional view of a braked member of a brake disc assembly according to a seventh embodiment of the invention.

FIG. 8 is a cross-sectional view of a braked member of a brake disc assembly according to an eighth embodiment of the invention.

FIG. 9 is a cross-sectional view of a braked member of a brake disc assembly according to a ninth embodiment of the invention.

FIG. 10 is a cross-sectional view of a brake disc assembly according to a tenth embodiment of the invention.

FIG. 11 is a cross-sectional view of a brake disc assembly according to an eleventh embodiment of the invention.

FIGS. 12-13 are cross-sectional views of part of a braked member of a brake disc assembly according to a twelfth and thirteenth embodiment of the invention.

FIGS. 14-15 are cross-sectional views of part of a displaceable member of a brake disc assembly according to an fourteenth and fifteenth embodiment of the invention.

FIGS. 16-19 are cross-sectional views of part of a displaceable member of aa brake disc assembly according to a sixteenth to twentieth embodiment of the invention.

FIG. 20 is a cross-sectional view of a brake disc assembly according to a twenty-first embodiment of the invention.

FIG. 21 is a cross-sectional view of a brake disc assembly according to a twenty-second embodiment of the invention.

### DETAILED DESCRIPTION

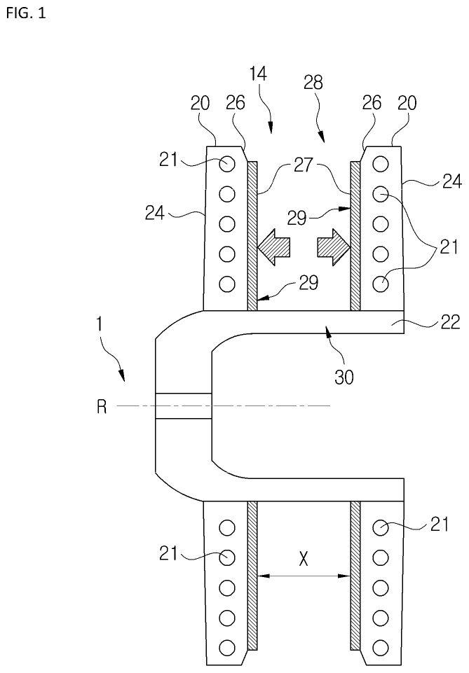

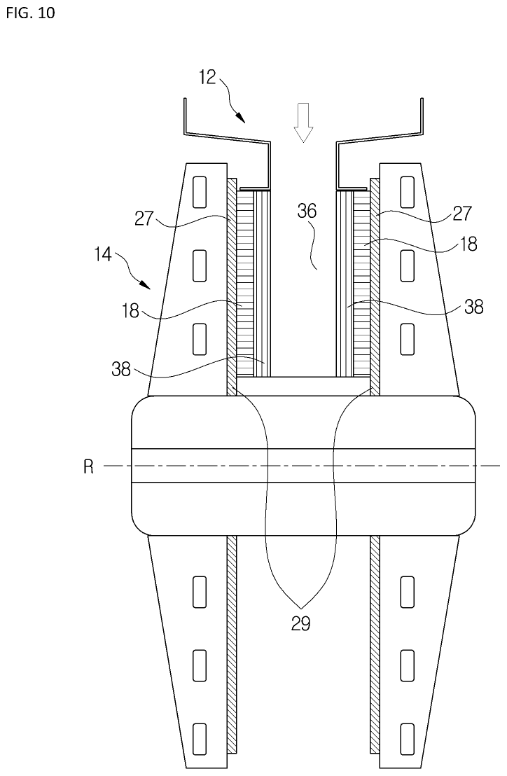

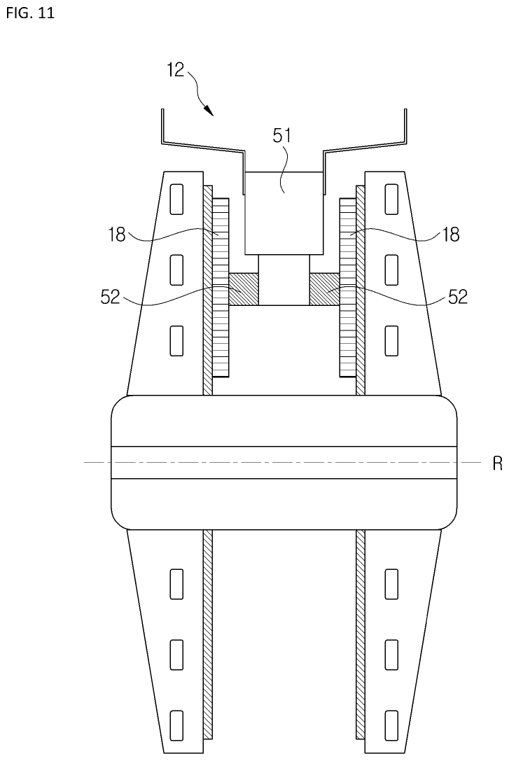

In FIG. 1, a cross-sectional view of a braked member 14 according to an embodiment of the invention is shown. The braked member 14 is part of a brake assembly 10 (see e.g. FIGS. 10 and 11) for braking a non-illustrated vehicle wheel whose position is indicated by reference sign 1. Accordingly, the vehicle wheel is positioned axially next to the braked member 14 and brake assembly 10. The vehicle wheel rotates about a rotational axis R. The cross-sectional plane of FIG. 1 (just like the cross-sectional planes of the further figures discussed below) extends vertically and includes the rotational axis R.

The braked member 14 jointly rotates with the vehicle wheel about the rotational axis R. The connection between the braked member 14 and the vehicle wheel may be formed according to configurations of known disc brakes, e.g. by connecting both to a wheel hub and/or to a common axle component.

The braked member 14 has two brake disc portions 20. In the shown example, these are provided and comprised by distinct brake disc members. The brake disc members are fixed to an axially extending connecting portion 22. Merely as an example, the connecting portion 22 is hollow and axially elongated with a C-shaped cross-section. The connecting portion 22 may also be referred to as a hub portion. It may receive and be mounted at an axle component.

The brake disc portions 20 each extend orthogonally and concentrically to the rotational axis R. They have a circular shape and may generally be configured similar to known brake discs, e.g. in terms of material and structure. The brake disc portions 20 may each comprise cavities 21 not each of which is marked with an own reference sign. The cavities 21 may extend locally, e.g. as compact hollow portions, or may extend circumferentially as rings. They may contribute to weight savings. Alternatively, the cavities 21 may define ventilations channels that are fluidically connected to the surroundings.

Each brake disc portion 20 has an axially outer face 24 and an axially inner face 26. The inner faces 26 of the brake disc portions 20 face inwards and face one another. The outer faces 24 face outwards and away from the respective inner face 26 of each brake disc portion 20.

At each inner face 26 a friction lining 27 is arranged. The friction linings 27 are each formed as circular discs having a flat ring-shape and extending concentrically about the rotational axis R. The friction linings 27 thus form continuous and closed rings with planar contact surfaces 29 facing one another (i.e., facing axially inwards). As indicated by arrows, the contact surfaces 29 are each to be contacted by a displaceable member 18 of a braking unit 16 discussed e.g. with respect to FIGS. 10 and 11 below. An axial distance x between the contact surfaces 27 and thus an axial width x of a space 28 confined by the brake disc portions 20 is marked in FIG. 1.

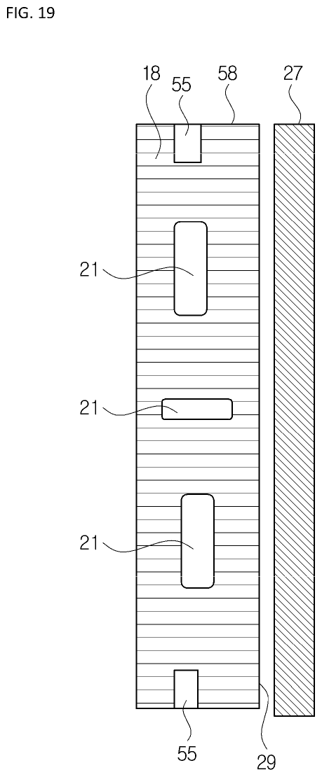

In the example of FIG. 1, the outer faces 24 are not used for generating braking forces, i.e. do not comprise any friction lining 27. An embodiment where the outer contact faces 24 are also used for generating brake forces is described below with respect to FIG. 19.

The inner faces 26 (and the friction linings 27 attached thereto) confine the space 28 in between them. Said space 28 forms a circumferentially extending slot or ring within the braked member 14. Its axial side faces are formed by the friction linings 27. A bottom face 30 of the space 28 is provided by the connecting portion 22.

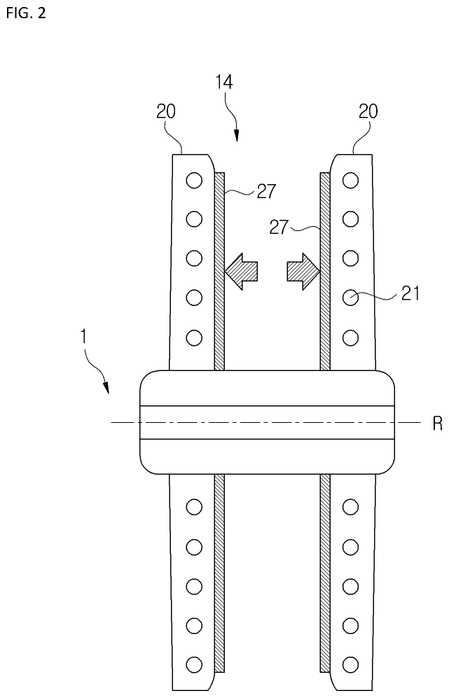

In the following, some further embodiments of braked members 14 are discussed. The embodiment of FIG. 2 differs from that of FIG. 1 substantially only with respect to the connecting portion 22. It is formed as a cylindric tube-like member having a substantially constant cross-section and e.g. configured to receive a non-illustrated axle component.

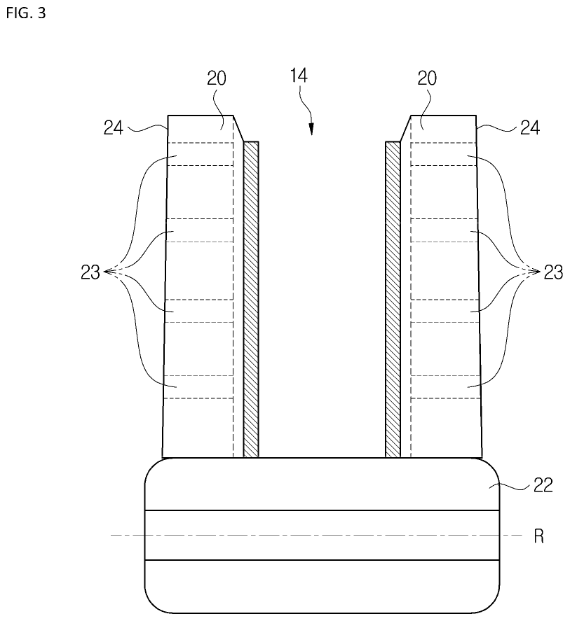

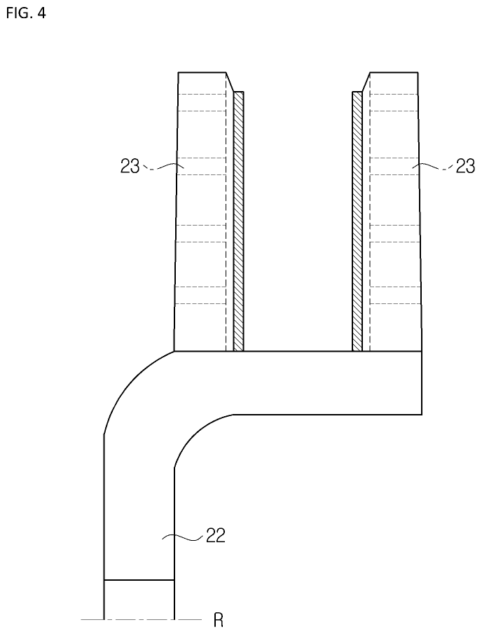

In FIG. 3, the braked member 14 is comparable to FIG. 2 in particular with respect to the connecting portion 22. For illustrative reasons, only the radial upper halves of the brake disc portions 20 are shown. In this embodiment, elongated recesses 23 (not each of which is marked by an own reference sign) extend from the outer faces 24 axially inward. These recesses 23 help to save weight and also increase a surface area for dissipating heat which the braked member 14 is exposed to when braking.

In FIG. 3, the braked member 14 is comparable to FIG. 1 in particular with respect to the connecting portion 22. Again, the braked member 14 is provided with elongated recesses 23 (not each of which is marked by an own reference sign) that are positioned similarly and provide same effects as in the embodiment of FIG. 3.

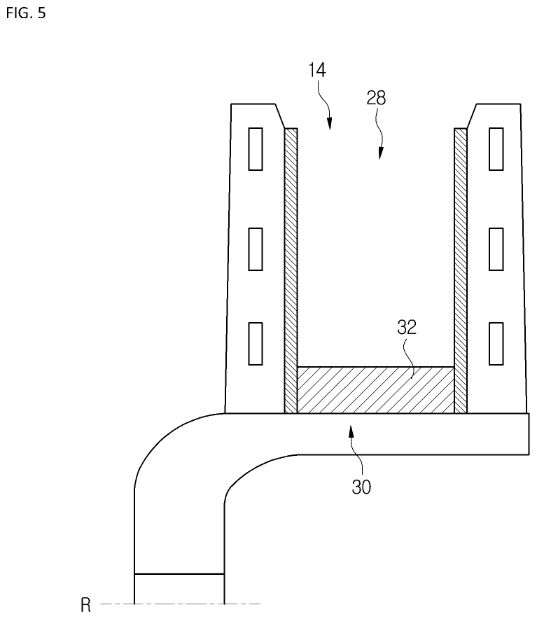

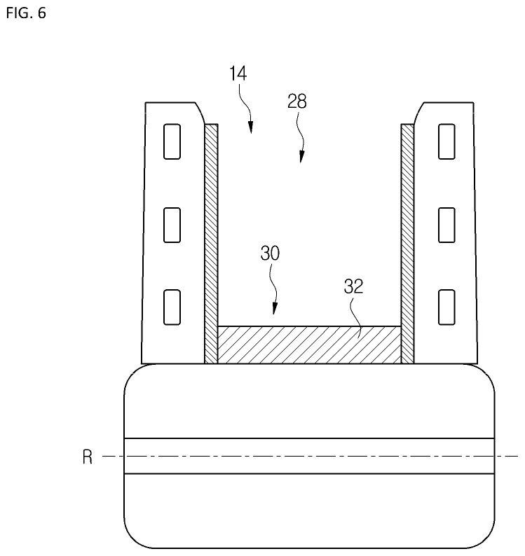

FIG. 5 and FIG. 6 (showing only a radial upper half of the brake disc portions 20) depict optional developments of the embodiments of FIGS. 1 and 2. In both cases, a brake dust collector 32 is arranged at and/or forms at least a section of the bottom face 30 of the space 28. The brake dust collector 32 is a ring-shaped member or layer that is arranged at an outer circumferential surface of the connecting portion 22. It comprises an adhesive to which brake dust sticks instead of being emitted into the environment.

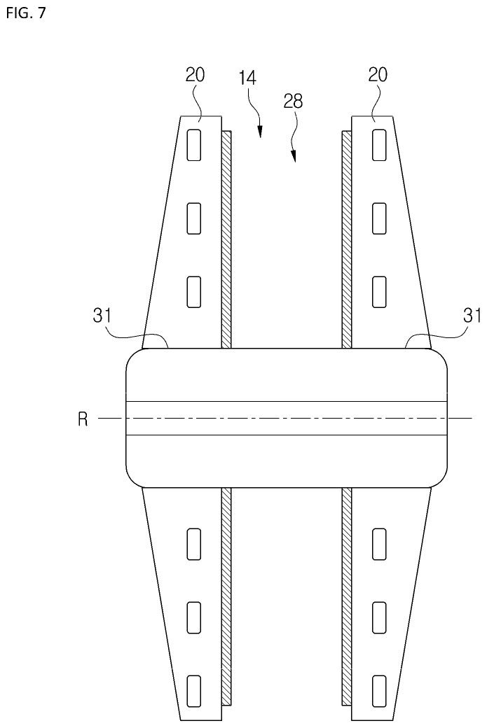

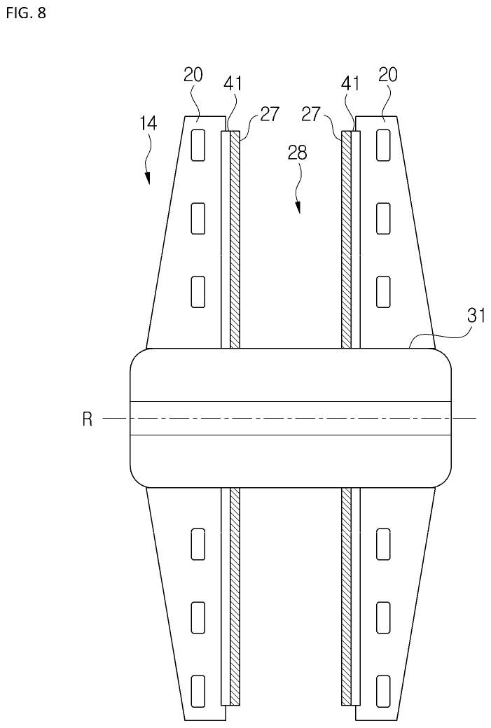

FIGS. 7 and 8 show braked members 14 whose brake disc portions 20 have an increased radially inner stiffness. Specifically, radially inner base portions 31 that are adjacent to (e.g. merged with or attached to) the connecting portion 22 are marked by an increased axial width. In a radial outer direction, this axial width decreases. In the depicted example, it decreases continuously and the radially upper and lower halves of each brake disc portion 20 thus have a triangular cross-sectional shape. This way, the base portions 31 which experience increased bending stresses are sufficiently stiff, while radially outer sections of the brake disc portions 20 which are less mechanically stressed are lighter.

FIG. 8 additionally shows an vibration-dampening underlayer 41 that is optionally placed between each friction lining 27 and inner face 26 of the brake disc portions 20.

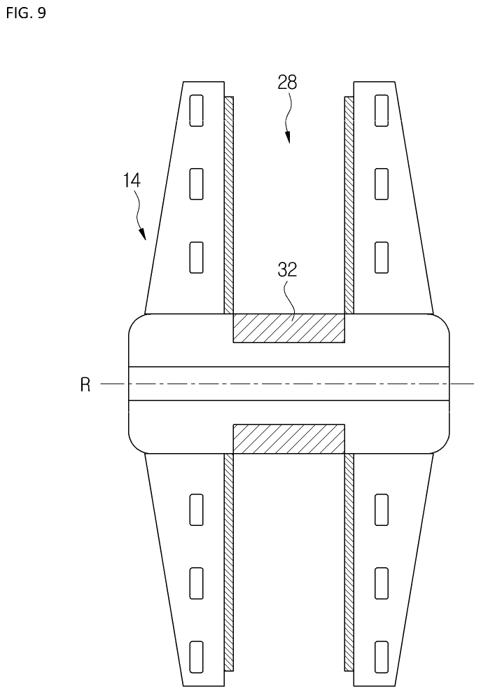

FIG. 9 shows as another optional feature of the displaceable member 14 of FIG. 7 a brake dust collector 32 similar to the embodiments of FIGS. 5 and 6.

FIGS. 10 and 11 show complete brake assemblies 10 comprising braked members 14 according to the embodiment of FIG. 7. The brake assemblies 10 also comprise a braking unit 16. The braking unit 16 at least partially extends into the space 28. In particular, it comprises displaceable members 18 that are preferably fully received within the space 28 and an actuator 12 for displacing the displaceable members 18.

The displaceable members 18 extend substantially in parallel to the inner friction linings 27 and/or the brake disc portions 20. At a face thereof facing the respectively adjacent friction lining 27, the displaceable members 18 each comprise a material that is different from and e.g. harder that the friction material of the friction lining 27. For example, said material may be a metallic material, such as cast iron. This increases the heat dissipation potential of the displaceable members 18. More precisely, a contact surface 29 of the left displaceable member 18 in FIG. 10 is directly adjacent and opposite to the left friction lining 27, whereas the contact surface 29 of the right displaceable member 18 in FIG. 10 is directly adjacent and opposite to the friction lining 27.

The displaceable members 18 are arranged at opposite sides of a housing 34 of the braking unit 16. The housing 34 may form or be formed by a brake caliper. Specifically, the displaceable members 18 are arranged so that their contact surfaces 29 face away from one another and face a respectively adjacent friction lining 27. Also, the displaceable members 18 are axially spaced apart from one another when viewed along the rotational axis R.

FIG. 10 shows an activated state of the brake assembly 10. Therefore, contrary to the inactive state, no axial gap exists between the contact surfaces 29 of the displaceable members 18 and each friction lining 27, so that theses contact one another to generate friction forces. When activated from an inactive state, the displaceable members 18 move axially apart from one another as indicated by arrows in FIG. 1. An axial distance between the displaceable members 18 is thus increased and each contact surface 29 is brought into contact with the respectively opposite friction lining 27. This generates frictional forces between the contact surfaces 29 and friction linings 27 which brake a rotation of the braked member 14. When deactivated, the displaceable members 18 are lifted off of a respectively adjacent friction lining 27 while reducing an axial distance between the displaceable members 18.

In FIG. 10, the braking unit 16 and specifically its housing 34 comprises a hydraulic chamber 36. The hydraulic chamber 36 is part of or resembles the actuator 12. According to a generally known configuration and as indicated by an arrow, a hydraulic pressure can be built up in said hydraulic chamber 36 for moving the displaceable members 18, thus activating the brake. In more detail, each displaceable member 18 is connected to a piston 38 that is slidingly received in the housing 34 and reaches into the hydraulic chamber 36. By increasing the pressure inside the hydraulic chamber 36, the pistons 38 are axially moved apart from one another and pushed outwards. When releasing the pressure in the hydraulic chamber 36, the pistons 38 and thus the displaceable members 18 axially retract, so that the contact surfaces 29 are lifted off and away from the respectively opposite friction lining 26. This retraction movement may be supported by known elastic seals which act on the pistons 38.

It is to be noted that the pistons 38 as well as at least part of the hydraulic chamber 36 as well as part of the housing 34 are received within the space 28.

Further, any of these members as well as the displaceable members 18 (and generally the braking unit 16 as a whole) may have a defined extension in the circumferential direction and/or orthogonally to the image plane so that a sufficiently large areal contact between the displaceable members 18 and the friction linings 27 can be formed. Preferably, this circumferential extension is limited to below of 180° or below of 135° to increase compactness and to save weight.

FIG. 11 shows an embodiment similar to FIG. 10, but having a different actuator 12. This actuator 12 comprises an electric motor 51. For axially moving the displaceable members 18 to and away from the friction linings 27, the electric motor 51 is connected to each displaceable member 18 by an optional gear stage or spindle mechanism 52.

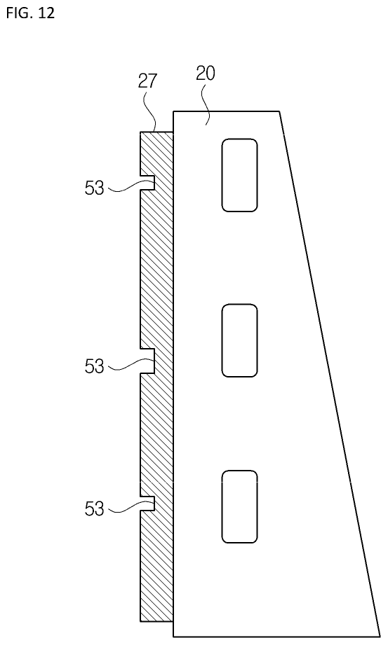

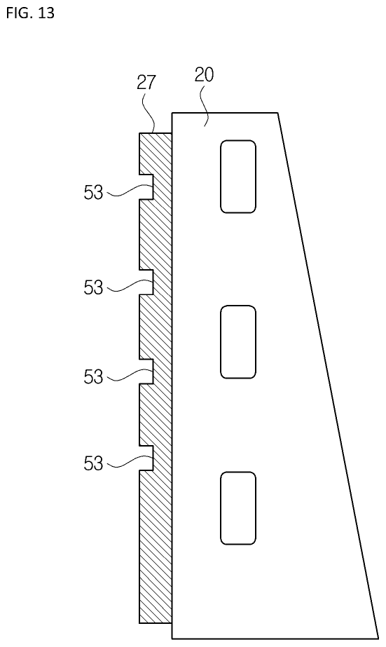

FIGS. 12 and 13 each show one upper half of a brake disc portion 20 comprised by the braked member 14 according to a further embodiment. In these examples, the contact surfaces 29 of the friction lining 27 comprise a number of recesses 53. These may be formed as circumferentially extending rings or ring segments. FIGS. 12 and 13 differ in terms of the number, dimensioning and positioning of said recesses 53, but are both non-limiting examples.

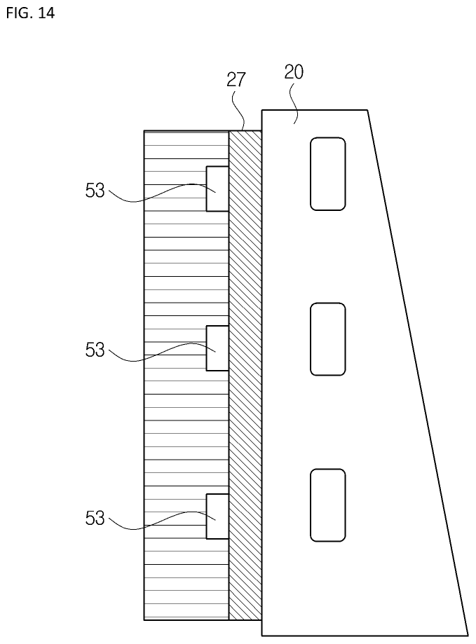

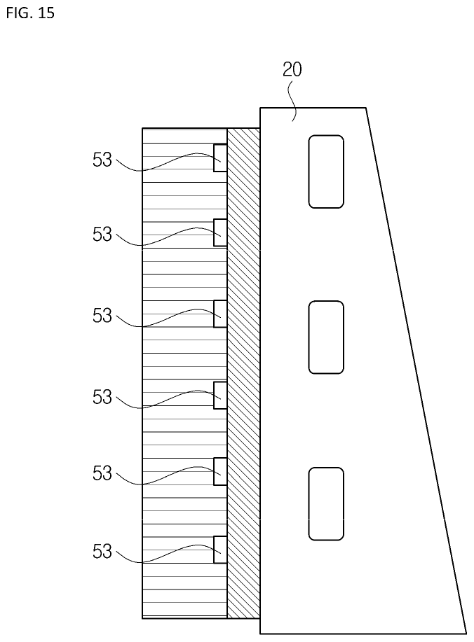

FIGS. 14 and 15 show displaceable members 18 in a state of contacting an adjacent brake lining 27. The displaceable members 18 have recesses 53 in their contact surfaces 29, with FIGS. 14 and 15 showing different and non-limiting numbers, dimensions and positions of said recesses 53.

The embodiments of FIGS. 12, 13 and 14, 15 may be combined, i.e. both of the brake linings 27 and displaceable members 18 may have recesses 53 in their respective contact surfaces 29. The recesses 53 in any of the brake linings 27 and displaceable members 29 may help to limit contact forces and/or vibrations resulting therefrom, thus reducing brake noises. Also, they may help to guide brake dust away from a contact area and e.g. radially inwards towards an optional brake dust collector 32.

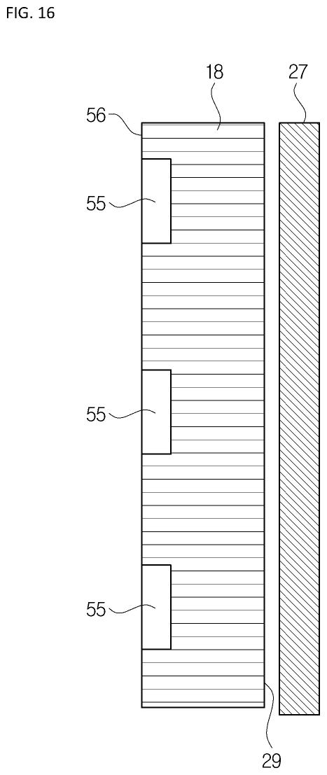

FIGS. 16-19 show exemplary configurations of displaceable members 18 having recesses 55. The recesses 55 are positioned outside of a contact surface 29 the displaceable members 18, said contact surface 29 facing an adjacent friction lining 27.

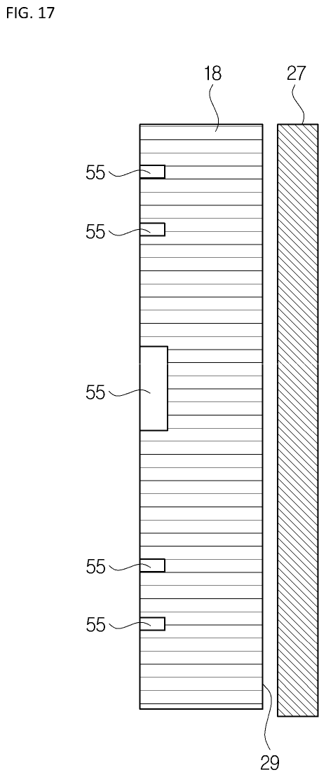

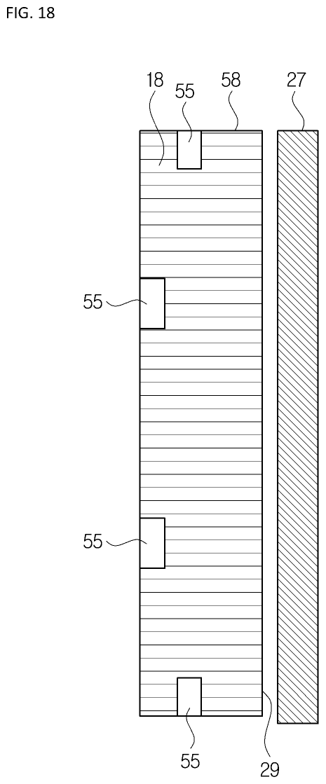

In FIGS. 16 and 17, the recesses 55 are positioned in a rear face 56 opposite the contact surface 29. The recesses 55 in FIG. 16 have identical dimensions, whereas these dimensions vary in FIG. 17. In FIG. 18, recesses 55 are (additionally or alternatively) positioned in circumferential faces 58 of the depicted displaceable members 18, e.g. at a radially upper or lower face. The recesses 55 help to save weight and to increase heat dissipation.

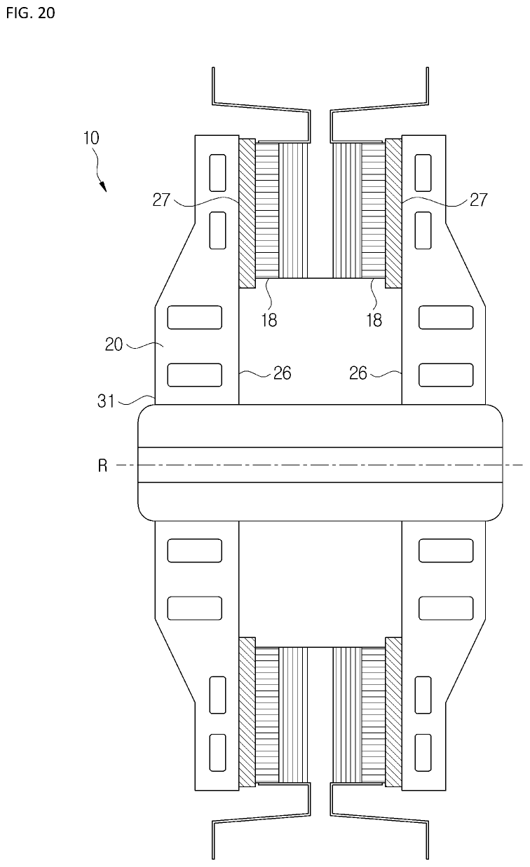

FIG. 20 shows a brake assembly similar to FIG. 10. In this case, a contact between the friction linings 27 and displaceable members 18 is only generated at a radial distance to or, in other words, radial offset from the connecting portion 22 (and/or base portion 31). Put differently, it is produced only in a radially outer portion or tip portion of the brake disc portions 20.

This increases the effective braking radius. In FIG. 20, this is achieved by positioning the friction linings 27 and brake unit 16 in said radially outer portion. As depicted, the friction linings 27 may thus not extend along the complete inner faces 26 of the brake disc portions 20, but may only be provided in the radially outer portion. This saves costs and weight.

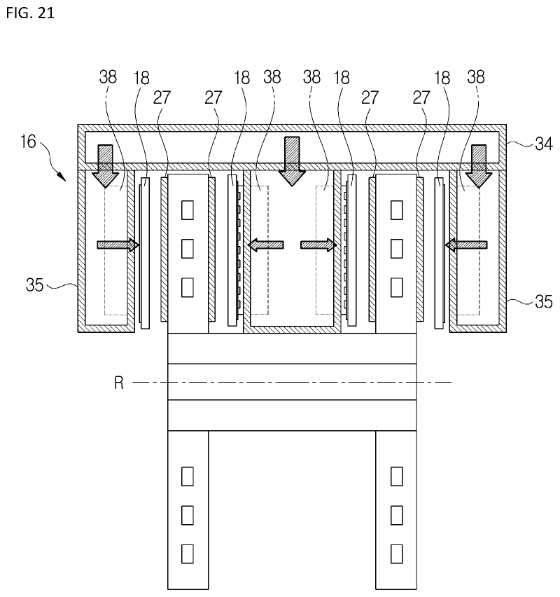

FIG. 21 shows a brake assembly 10 according to another embodiment. In this case, the outer contact faces 24 of the brake disc portions 20 are each contacted by a displaceable member 18 as well to generate additional brake forces.

Accordingly, the braking unit 16 also comprises two outer displaceable members 18 each being adjacent to one of the outer faces 24. At said outer faces 24, a friction lining 27 is arranged similar to the inner faces 26. In the shown example, these displaceable members 18 are configured similarly to the inner displaceable members 18 that are arranged in the circumferential space 28 of the braked member 14.

The housing 34 of the brake unit 16 has axially outer portions 35 that face the outer faces 24. The axially outer portions 35 are axially positioned further outwards compared to the outer faces 24. Each axially outer portion 35 receives a piston 38 so that a displaceable member 18 arranged at the respective axially outer portion 35 can be displaced in a similar manner as described above e.g. with respect to FIGS. 10 and 11. For doing so, the hydraulic chamber 36 also extends into the axially outer portions 35. The inner displaceable members 18 are generally configured and displaced similar to the embodiments discussed above.

In order to generate brake forces, a hydraulic pressure within the hydraulic chamber 36 is built up, upon which all four displaceable members 18 are displaced simultaneously towards their respectively opposite friction lining 27.

Thus, one single actuator 12 comprising said hydraulic chamber 36 suffices to activate the braking function.

What is claimed is:

1. Brake assembly for a vehicle wheel,
the brake assembly comprising:
a braked member that is coupable or coupled to the vehicle wheel for a joint rotation therewith about a rotational axis, the braked member having friction linings that are arranged at an axial distance from one another; and
a braking unit that comprises an actuator and at least two displaceable members, the displaceable members being positioned in between the friction linings,
wherein the actuator is configured move the displaceable members axially apart from one another, thereby bringing each displaceable member into contact with one of the friction linings of the braked member.

2. Brake assembly according to claim 1,
wherein the friction linings face each other.

3. Brake assembly according to claim 1,
wherein the friction linings form at least part of opposite side faces of a space in which the displaceable members are at least partially received.

4. Brake assembly according to claim 3,
wherein a brake dust collector is arranged within said space, in particular at a bottom face that extends in between the friction linings.

5. Brake assembly according to claim 1,
wherein the displaceable members are movable apart from one another along an axis extending in parallel to the rotational axis.

6. Brake assembly according to claim 1,
wherein the displaceable members each comprise a material that is harder and/or more wear resistant than a material comprised by the friction linings.

7. Brake assembly according to claim 1,
wherein the friction linings are each comprised by brake disc portions of the braked member.

8. Brake assembly according to claim 7,
wherein the brake disc portions extend in parallel to one another, in particular wherein the brake disc portions each extend orthogonally to the rotational axis of the braked member.

9. Brake assembly according to claim 1,
wherein each of the displaceable members is displaceable relative to a housing (34) of the braking unit and relative to one another.

10. Brake assembly according to claim 1,
wherein the actuator comprises one of an electric motor and a hydraulic chamber, each of which is configured to generate the force for moving both of the displaceable members.

11. Brake assembly according to claim 10,
wherein at least part of the electric motor or hydraulic chamber are received in the space.

12. Brake assembly according to claim 1,
wherein each of the displaceable members and the friction linings have a contact surface for contacting a respective other of the displaceable members and the friction linings, wherein at least one of the displaceable members and the friction linings has at least one recess in its contact surface.

13. Brake assembly according to claim 1,
wherein at least one of the displaceable members comprises at least one cavity and/or comprises at least one recess in a portion facing away from a respectively adjacent friction lining.

14. Brake assembly according to claim 1,
wherein the braked member comprises at least one underlayer (41) at which one of the friction linings is arranged.

15. Brake assembly according to claim 1,
wherein at least one of the friction linings has a ring shape or comprises a number of ring segments.

16. Brake assembly according to claim 1,
wherein a contact between the friction lining and displaceable members is formed only in a radially outer portion of the braked member.

17. Method of operating a brake assembly for a vehicle wheel,
the brake assembly comprising:
a braked member that is coupable or coupled to the vehicle wheel for a joint rotation therewith about a rotational axis, the braked member (22) having friction linings that are arranged at an axial distance from one another; and
a braking unit that comprises at least two displaceable members, the displaceable members being positioned in between the friction linings,
wherein the method comprises: moving the displaceable members axially apart from one another, thereby bringing each displaceable member into contact with one of the friction linings of the braked member.
